(19) United States
(12) Patent Application Publication
(10) Pub. No.: US 2006/0250394 A1
(43) Pub. Date: Nov. 9, 2006

(54) Rendering methods and related devices

(75) Inventor: Lien-Hsiang Sung, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/288,857

(22) Filed: Nov. 29, 2005

(30) Foreign Application Priority Data
May 5, 2005 (TW) 94114502

(51) Int. Cl. G06T 15/40

(52) U.S. Cl. 345/422

(57) ABSTRACT

Rendering methods and related devices. A distance between a user-defined clip plane (UDCP) and a near plane is calculated, and a buffer is set accordingly. A distance between each vertex of a triangle and the near plane is calculated, and a distance between a pixel in the triangle and the near plane is calculated according to the distances from respective vertices to the near plane. The distance from the pixel to the near plane is compared with a corresponding value in the buffer. If the distance from the pixel to the near plane is greater than the value, the pixel is not rendered.

### BACKGROUND

The invention relates to rendering methods, and particularly to rendering methods for use in UDCPs (User-Defined Clip Planes), and related devices.

Respective polygons are projected onto a plane such as a screen for display. If several polygons are projected onto the same pixel on the plane, the polygon closest to the plane (the polygon closest to a user) is shown on the plane, such that the polygon can be viewed. FIG. 1 is a schematic diagram illustrating Z-buffer technique. A Z-buffer is used to compare the distances from respective polygons to the plane. As shown in FIG. 1, three polygons (101, 102 and 103) are in a space, respective pixels (I, J and K) on the polygons (101, 102 and 103) are projected to the same pixel (x,y) on a plane 100. The distances (Z value) of respective polygons (101, 102 and 103) to the plane 100 are obtained by applying (x,y) to plane equations of respective polygons (101, 102 and 103). Comparison of the Z value of respective polygons (101, 102 and 103) shows polygon 101 as closest to the plane 100, such that the pixel (x,y) on the plane 100 displays the color of the pixel I on the polygon 101.

In graphic design, users can define specific clip planes to review the physical structure of an object under different cross-sections, or to limit the range of object to be rendered. For example, FIG. 2 shows a 3D rectangle 200. The rectangle 200 is sectioned by a face forward UDCP 300 into a visible part 210 in front of the UDCP 300, and an invisible part 220 at the back of the UDCP 300, as shown in FIG. 3. It is understood that a face forward UDCP means the part of the object in front of the UDCP is visible, with the part of object at the back of the UDCP hidden. A face backward UDCP means the part of object at the back of the UDCP is visible, with the part of object in front of the UDCP hidden.

In conventional triangle rendering, the distance from each vertex of a triangle to a UDCP is calculated, and the distance from each pixel in the triangle to the UDCP is obtained based on the distances from respective vertices to a UDCP using interpolation. If the distance from a pixel to the UDCP is negative, indicating that the pixel is at back of the UDCP, the pixel is not rendered. FIG. 4 is a schematic diagram illustrating a conventional rendering method used in UDCP. As shown in FIG. 4, a triangle includes three vertices A, B and C. A unit distance difference (dx and dy) is calculated according to the distances (dA, dB and dC) from respective vertices (A, B and C) to UDCP, and the distances from respective pixels (P1, P2 and Pk) to the UDCP are calculated based on the vertex position and unit distance difference using interpolation. In this example, if the UDCP is a face forward UDCP, pixels P1 and P2 are rendered, pixel Pk is not rendered since the-distance from pixel Pk to the UDCP is negative.

Conventionally, since the distances from all pixels comprising the vertices and other pixels in a triangle to a UDCP must be calculated, if several UDCPs are provided, it is time-consuming, reducing rendering efficiency.

### SUMMARY

Rendering methods and related devices are provided.

In an embodiment of a rendering method, a distance between a UDCP and a near plane (projection plane) is calculated, and a buffer is set accordingly. A distance between each vertex of a triangle and the near plane is calculated, and a distance between a pixel in the triangle and the near plane is calculated according to the distances from respective vertices to the near plane. The distance from the pixel to the near plane is compared with a corresponding value in the buffer. If the distance from the pixel to the near plane is greater than the value, the pixel is not rendered.

In an embodiment of a rendering method, a distance between a first UDCP and a near plane (projection plane) is calculated, and a first buffer is set accordingly. A distance between a second UDCP and the near plane is calculated, and a second buffer is set accordingly. A distance between each vertex of a triangle and the near plane is calculated, and a distance between a pixel in the triangle and the near plane is calculated according to the distances from respective vertices to the near plane. The distance from the pixel to the near plane is compared with a corresponding first value in the first buffer. If the distance from the pixel to the near plane is greater than the first value, the pixel is not rendered. The distance from the pixel to the near plane is compared with a corresponding second value in the second buffer. If the distance from the pixel to the near plane is less than the second value, the pixel is not rendered.

Rendering methods may take the form of program code embodied in tangible media. When the program code is loaded into and executed by a machine, the machine becomes an apparatus for practicing the disclosed method.

### DESCRIPTION OF THE DRAWINGS

The aforementioned features and advantages will become apparent by referring to the following detailed description with reference to the accompanying drawings, wherein:

FIG. 1 is a schematic diagram illustrating Z-Buffer technique;

FIG. 2 shows a 3D rectangle;

FIG. 3 shows the 3D rectangle in FIG. 2 sectioned by a UDCP 300;

FIG. 4 is a schematic diagram illustrating a conventional rendering method for use in UDCPs;

FIG. 5 is a schematic diagram illustrating an embodiment of a rendering device; and

FIG. 6 is a flowchart of an embodiment of a rendering method.

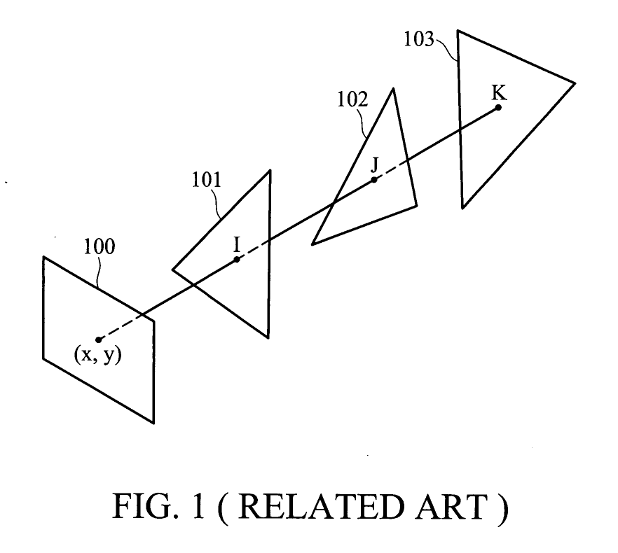

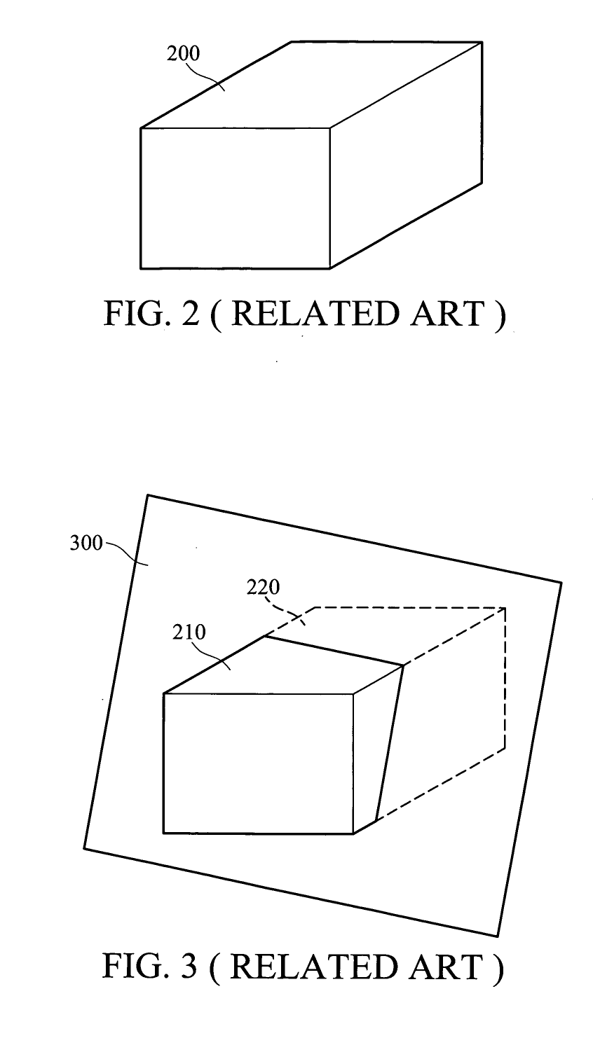

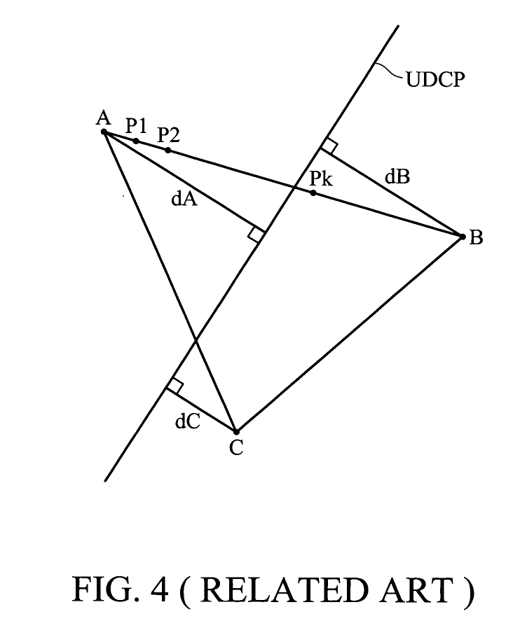

### DESCRIPTION

Rendering methods and related devices are provided.

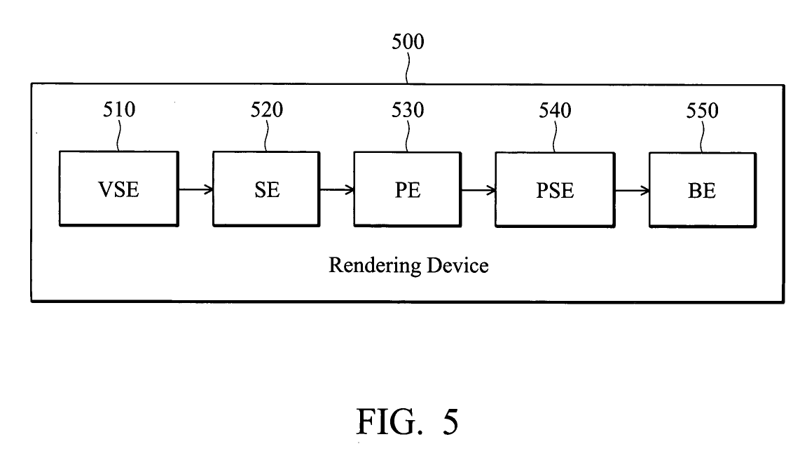

FIG. 5 is a schematic diagram illustrating an embodiment of a rendering device. The rendering device 500 comprises a VSE (Vertex Shader Engine) 510, a SE (Setup Engine) 520, a PE (Primitive Engine) 530, a PSE (Pixel Shader Engine) 540, and a BE (Burst Engine) 550.

The VSE 510 calculates the distance between each vertex of respective triangles of an object and a projection plane. The VSE 510 further calculates the distance between each vertex of respective triangles of an object and at least one UDCP. It is understood that the VSE 510 calculates a sign bit of the distance from each vertex of a triangle to the UDCP, and determines whether to render a triangle accordingly. In some embodiments, if all sign bits corresponding to all vertices are negative, the triangle is ignored, and no subsequent process is performed. The SE 520 calculates the unit distance difference (dx and dy) between pixels in the triangle according to the distances from respective vertices of the triangle to the projection plane. The PE 530 calculates the distances from respective pixels in the triangle to the projection plane based on the vertex positions and the unit distance difference using an interpolation method. The PSE 540 compares the distance from each pixel to the projection plane with the values in two buffers, filtering pixels to be ignored. The buffers are discussed later. The BE 550 renders the remaining pixels. It is understood that the VSE 510, SE 520, PE 530, PSE 540, and BE 550 may have other functions and corresponding operations in a complete rendering device, and are not limited thereto.

The buffers comprise a near plane buffer and a far plane buffer (not shown in FIG. 5). In some embodiments, the size of the near plane and far plane buffers equals the monitor size. The near plane buffer is set according to the distances from face backward UDCPs to a projection plane. If several face backward UDCPs are provided, a value corresponding to a pixel on the projection plane in the near plane buffer is set as the distance from a corresponding pixel on a farthest UDCP to the projection plane. The far plane buffer is set according to the distances from face forward UDCPs to a projection plane. If several face forward UDCPs are provided, a value corresponding to a pixel on the projection plane in the far plane buffer is set as the distance from a corresponding pixel on a closest UDCP to the projection plane. It is understood that the far plane buffer works as Z-buffer in rendering, that is the far plane buffer updates its values according to the Z-buffer technique. The Z-buffer technique is well-known, and omitted herefrom.

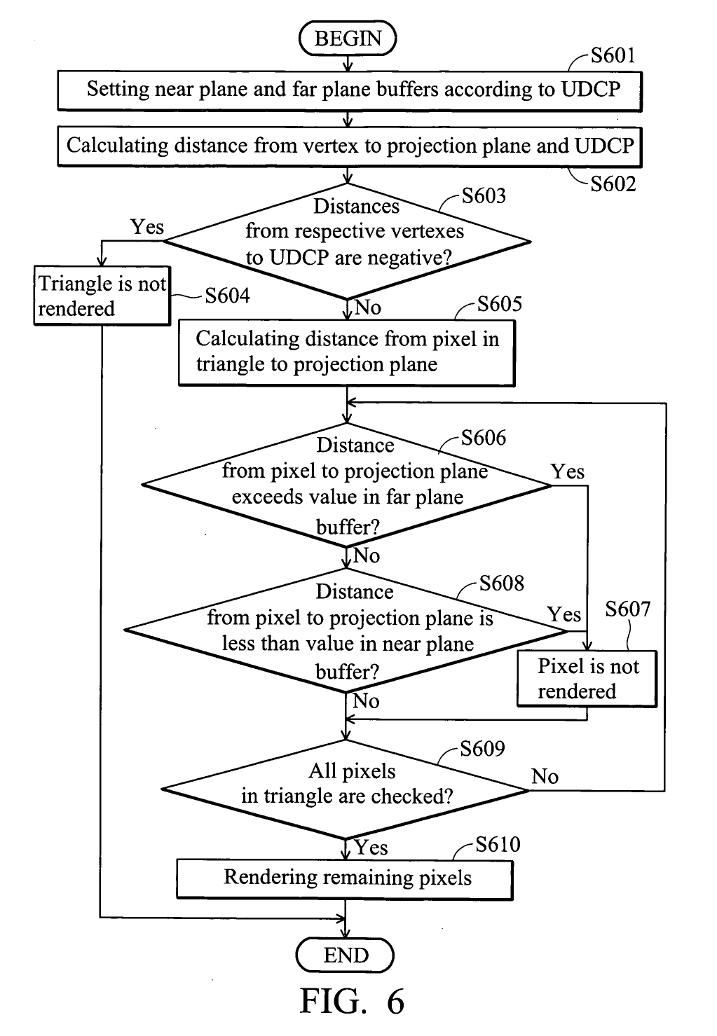

FIG. 6 is a flowchart of an embodiment of a rendering method. It is understood that a triangle of an object is discussed in this embodiment, with other triangles of the object undergoing the same procedure.

In step S601, the near plane buffer and the far plane buffer are set according to UDCPs. The near plane buffer is set according to the distance from at least one face backward UDCP to a projection plane. If several face backward UDCPs are provided, a value corresponding to a pixel on the projection plane in the near plane buffer is set as the distance from a corresponding pixel on a farthest UDCP from the projection plane. If no face backward UDCP is provided, the value in the near plane buffer is set to 0. Additionally, the far plane buffer is set according to the distance from at least one face forward UDCP to a projection plane. If several face forward UDCPs are provided, a value corresponding to a pixel on the projection plane in the far plane buffer is set as the distance from a corresponding pixel on a closest UDCP to the projection plane. If no face forward UDCP is provided, the value in the far plane buffer is set to 1.

In step S602, the distance from each vertex of the triangle to a projection plane and the distance from each vertex of the triangle to each UDCP are calculated. It is understood that, in some embodiments, only a sign bit is used in calculation of the distance between vertex and UDCP. In step S603, it is determined whether the distances from respective vertices to the UDCP are all negative. In other words, it is determined whether all vertices are at the back of a face forward UDCP, or in front of a face backward UDCP. If so, in step S604, the triangle is not rendered. If not, in step S605, the distance from each pixel in the triangle to the projection plane is calculated based on the distances from respective vertices to the projection plane using an interpolation method. For each pixel, in step S606, it is determined whether the distance from the pixel in the triangle to the projection plane exceeds a corresponding value in the far plane buffer. If so, in step S607, the pixel is discarded, and is not rendered. If not, in step S608, it is determined whether the distance from the pixel in the triangle to the projection plane is less than a corresponding value in the near plane buffer. If so, in step S607, the pixel is discarded, and is not rendered. If not, in step S609, it is determined whether all pixels have been checked. If not, the procedure returns to step S606, wherein another pixel is checked. If so, in step S610, the remaining pixels are rendered. It is understood that the far plane buffer updates its values, and the pixel closest to the projection plane is rendered if several pixels are projected to the same pixel on the projection plane according to the Z-buffer technique.

Rendering methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. A rendering method, comprising:
calculating a distance between a first UDCP (User-Defined Clip Plane) and a projection plane, and setting a first buffer accordingly;
calculating a distance between each vertex of a first triangle and the projection plane, and calculating a distance between a first pixel in the first triangle and the projection plane according to the distances from respective vertices to the projection plane;
comparing the distance from the first pixel to the projection plane with a corresponding first value in the first buffer; and
if the distance from the first pixel to the projection plane is greater than the first value, not rendering the first pixel.

2. The method of claim 1 further comprising:
calculating a distance between a second UDCP and the projection plane, and setting a second buffer accordingly;
comparing the distance from the first pixel to the projection plane with a corresponding second value in the second buffer; and
if the distance from the first pixel to the projection plane is less than the second value, not rendering the first pixel.

3. The method of claim 1 further comprising:
calculating a distance from each vertex to the first UDCP; and
if all distances from respective vertices to the first UDCP are negative, not rendering the first triangle.

4. The method of claim 3 comprising calculating a sign bit of the distance from each vertex to the first UDCP, and determining whether to render the first triangle accordingly.

5. The method of claim 1 further comprising calculating the distance from the first pixel to the projection plane based on the distances from respective vertices to the projection plane using an interpolation method.

6. The method of claim 1 further comprising:
calculating a distance between each vertex of a second triangle and the projection plane, and calculating a distance between a second pixel in the second triangle and the projection plane according to the distances from respective vertices to the projection plane; and
if the distance from the second pixel to the projection plane is less than the first value in the first buffer, setting the first value as the distance from the second pixel to the projection plane.

7. A rendering method, comprising:
calculating a distance between a first UDCP (User-Defined Clip Plane) and a projection plane, and setting a first buffer accordingly;
calculating a distance between a second UDCP and the projection plane, and setting a second buffer accordingly;
calculating a distance between each vertex of a first triangle and the projection plane, and calculating a distance between a first pixel in the first triangle and the projection plane according to the distances from respective vertices to the projection plane;
comparing the distance from the first pixel to the projection plane with a corresponding first value in the first buffer;
if the distance from the first pixel to the projection plane is greater than the first value, not rendering the first pixel;
comparing the distance from the first pixel to the projection plane with a corresponding second value in the second buffer; and
if the distance from the first pixel to the projection plane is less than the second value, not rendering the first pixel.

8. The method of claim 7 further comprising:
calculating a distance from each vertex to the first UDCP; and
if all distances from respective vertices to the first UDCP are negative, not rendering the first triangle.

9. The method of claim 8 comprising calculating a sign bit of the distance from each vertex to the first UDCP, and determining whether to render the first triangle accordingly.

10. The method of claim 7 further comprising:
calculating a distance between each vertex of a second triangle and the projection plane, and calculating a distance between a second pixel in the second triangle and the projection plane according to the distances from respective vertices to the projection plane; and
if the distance from the second pixel to the projection plane is less than the first value in the first buffer, setting the first value as the distance from the second pixel to the projection plane.

11. A rendering device, comprising:
means for calculating a distance between a first UDCP (User-Defined Clip Plane) and a projection plane, and setting a first buffer accordingly;
means for calculating a distance between each vertex of a first triangle and the projection plane, and calculating a distance between a first pixel in the first triangle and the projection plane according to the distances from respective vertices to the projection plane; and
means for comparing the distance from the first pixel to the projection plane with a corresponding first value in the first buffer, and not rendering the first pixel if the distance from the first pixel to the projection plane is greater than the first value.

12. The device of claim 11 further comprising:
means for calculating a distance between a second UDCP and the projection plane, and setting a second buffer accordingly; and
means for comparing the distance from the first pixel to the projection plane with a corresponding second value in the second buffer, and not rendering the first pixel if the distance from the first pixel to the projection plane is less than the second value.

13. The device of claim 11 further comprising:
means for calculating a distance from each vertex to the first UDCP; and
wherein if all distances from respective vertices to the first UDCP are negative, the first triangle is not rendered.

14. The device of claim 11 further comprising:
means for calculating a distance between each vertex of a second triangle and the projection plane, and calculating a distance between a second pixel in the second triangle and the projection plane according to the distances from respective vertices to the projection plane; and
means for setting the first value as the distance from the second pixel to the projection plane if the distance from the second pixel to the projection plane is less than the first value in the first buffer.
